(19) United States
(12) Patent Application Publication
(10) Pub. No.: US 2008/0205230 A1
(43) Pub. Date: Aug. 28, 2008

(54) Speed-Down During Linking

(75) Inventors: Michiel Johannes Soede, Eindhoven (NL); Herman Van Der Kall, Veldhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/993,982

(22) PCT Filed: Jun. 29, 2006
(86) PCT No.: PCT/IB06/52180

§ 371 Date: Dec. 27, 2007

Related U.S. Application Data
(60) Provisional application No. 60/695,085, filed on Jun. 29, 2005.

(51) Int. Cl. G11B 27/36; G11B 27/24; G11B 20/12; G11B 20/10; G11B 19/26; G11B 7/125; G11B 7/0045

(52) U.S. Cl. 369/53.25

(57) ABSTRACT

In the invention herein a recordable optical disc is provided with embossed windings of a spiral track or circular tracks in a recording layer of phase change material and with embossed address/timing information located between adjacent windings. User data is received for recording on the disc. The data is written by controlling a laser beam scanning the winding to form marks of different phases of the phase change material at a higher disc speed while reading an address from the disc. The writing is occasionally interrupted in order to calibrate write parameters in order to improve the write quality. After the calibration linking is performed by jumping to a position just before the writing was interrupted, and determining the current position depending on an address read from the disc, and tracking to the position that the writing was interrupted. When an error occurs in reading the address information from the disc during linking at a higher disc speed, then the disc speed is reduced to a lower disc speed and linking is performed at the slower disc speed. After successful linking, writing of the user data continues at the lower disc speed or the disc speed is increased and writing continues at the higher disc speed.

The invention herein is related to the field of recording user data on writable optical media discs such as DVDs.

In recorders for such writable optical media, writing of user data is occasionally interrupted, for example, in order to calibrate parameters of the drive so as to improve the write quality. In order to resume the writing, the recorder uses a process known as linking. In linking the scanning jumps back to a position just before the writing was interrupted, and the recorder reads the address to determine the exact current position of the laser spot on the DVD, and then the recorder tracks to the location that writing was interrupted and resumes the writing of user data.

If the recorder can not read the address during linking then the linking is repeated until either linking succeeds or a timeout or repeat limit is reached which is called a linking failure. When a linking failure occurs then recording is canceled which results in a corrupted disc.

In DVD minus implementations (i.e. DVD-R, DVD-RW), timing and address information is provided during disc manufacture by embossed LPPs (land prepits) that are located between tracks. During linking, the address is determined by reading the LPP signal, but the LPP signal is difficult to read, especially between written and non-written areas especially near the outside of the disc and at higher writing speeds.

Those skilled in the art are directed to the following citations:

U.S. Pat. No. 6,442,117 to Saiki et. al. discloses slowing read/write speed so as to read recorded user data more reliably.

Publication US20030072229 to Hasegawa et. al. discloses interrupting writing of a CD-R/-RW when a write error occurs and resuming writing at a reduced write speed.

Patent EP1014373 to sugiyama et. al. discloses reducing reading speed of user information when read errors occur.

Patent EP1227491 to Haruyasu et. al. discloses troubles in reading LPPs.

The above citations are hereby incorporated herein in whole by reference for background purposes.

In the invention herein, when the a linking failure occurs at a higher disc speed, then the recorder reduces the disc speed to a lower disc speed so that linking is more reliable. Thus, linking failures can be overcome and writing is more reliable.

After slowing the disc speed for linking, then the recorder may increase the disc speed to the higher speed for continued writing or the recorder may continue to write at the slower disc speed if the slower speed is adequate.

The invention is applicable to all optical storage recording devices especially those that have problems linking at higher recording speeds, but have less problems linking at lower speeds.

These and other aspects of the invention will be apparent to those skilled in the art from the following detailed description of the invention with reference to the following drawings.

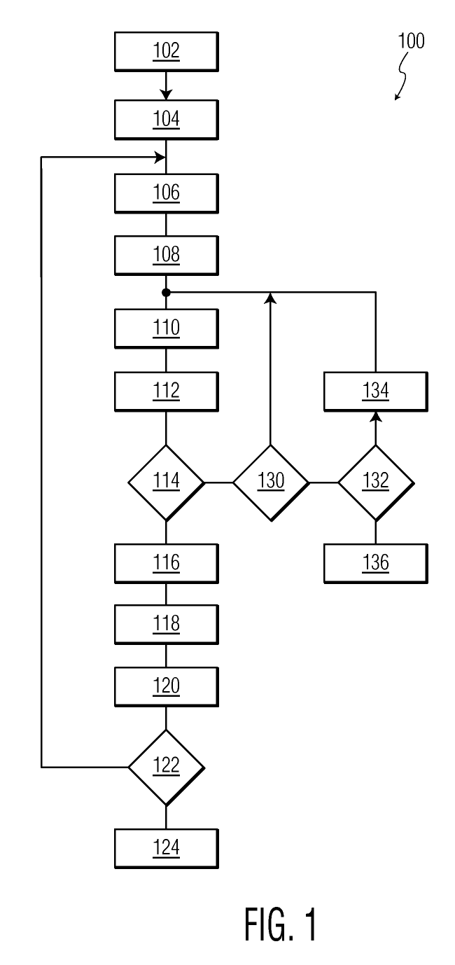

FIG. 1 is a flow diagram describing a specific embodiment of the method of the invention.

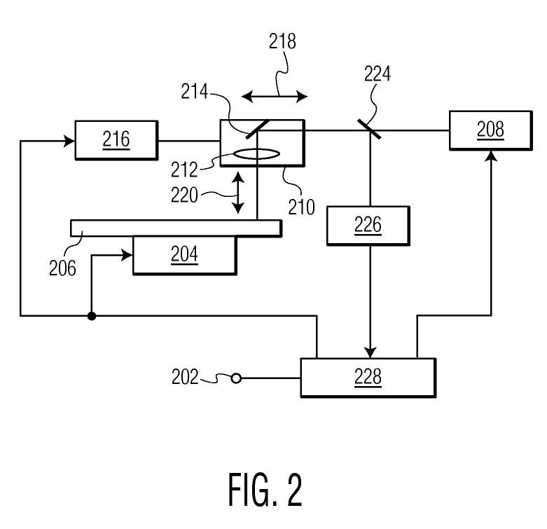

FIG. 2 is a schematic representation of a specific embodiment of a recorder of the invention showing only selected relevant portions of the recorder.

In FIG. 1, flow diagram 100 illustrates a specific example of a method according to the invention herein. In step 102 a recordable optical disc is provided with embossed windings of a spiral track or circular tracks in a recording layer of phase change material and with embossed address/timing information between adjacent windings. In step 104, user data is received for recording on the disc. In step 106, a portion of the user data is written at a higher disc speed while reading addresses from the winding. The data is written by controlling the power of a laser beam that scans the winding so as to form marks. The marks consist of alterations between different phases of the phase change material, the different phases having different properties e.g. reflectivity.

In step 108, the writing is occasionally interrupted to re-calibrate write parameters in order to improve the write quality. In step 110, the scanning is jumped to a position on the winding just before the writing was interrupted. In step 112 the address is read from the winding to determine the current position of scanning. In step 114 if the current position can be determined than the process continues to step 116 in which, the winding is tracked to the position that the writing was interrupted. In step 118, writing of the portion of the user data is continued from the position at which the writing was interrupted. In optional step 120 disc speed is set at the higher write speed. In step 122, if there is more user data, then the process continues at step 106 and otherwise if the user data is all written then the process continues at step 124 in which the process is terminated.

In step 114, if the current position after the jump can not be determined, then in step 130 if a predetermined timeout or retry threshold has not been reached then flow continues at step 110, and otherwise if the timeout or repeat count has reached the predetermined threshold, then flow continues at step 132. In step 132, if the disc speed has not been reduced, then the timeout or repeat count of step 130 is reset and then the flow continues at step 134. In step 134 the disc speed is reduced to a lower disc speed for increasing the reliability of determining the current position, and the process continues at step 110. In step 132, if the disc speed has already been reduced then in step 136 an error signal is generated and the process terminates.

FIG. 2 illustrates a specific example of the optical disc recorder 200 of the invention herein. Input 202 receives user data. The data may include text, audio, and/or video, for example, as an MPEG multimedia stream. Turntable 204 holds and rotates optical disc 206. Laser 208 produces a radiation beam. Optical head 210 includes a lens system 212 for focusing the beam and a mirror 214 for directing the beam about perpendicularly toward the disc for scanning the disc with the beam as the disc rotates. Head servo 216 controls the lateral position 218 of the optical head with respect to the beam at the disc in order to follow a predefined spiral or circular winding of a recording layer of the rotating disc. The head servo also controls the axial position 220 of the lens 212 with respect to the beam at the disc in order to focus the beam into a spot on the winding. The head servo typically consists of multiple servo systems which are independently controlled.

The beam is reflected from the spot on the winding in the recording layer of the optical disc. The reflected beam is directed to a beam splitter 224 that directs the reflected beam to a photo detector 226 that converts the reflected beam into an electronic read signal.

The read signal is routed to controller 228 which is adapted to control the operation of turntable 204 and laser 208 and head servo 216 depending on the read signal in accordance with the method of the invention in FIG. 1. More specifically, the controller controls the laser to write the user data on the winding; the controller occasionally interrupts the writing in order to calibrate parameters of the drive in order to improve the write quality; after the calibration, the controller controls the head servo to move the beam to a position just before the position on the track at which the writing was interrupted; the controller determines the current position of the spot on the winding depending on an address determined from the read signal; but when the address can not be determined from the read signal at the higher speed, then the controller controls the turntable to reduce the rotational disc speed from a higher speed to a lower speed for more reliably determining the current position. After determining the address at the lower speed, the controller may increases the disc speed to the higher speed for continued writing of the user data.

Although this invention has been described with reference to particular embodiments, it will be appreciated that many variations will be resorted to without departing from the spirit and scope of this invention as set forth in the appended claims. The specification and drawings are accordingly to be regarded in an illustrative manner and are not intended to limit the scope of the appended claims.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function;
e) any of the disclosed elements may be comprised of hardware portions (e.g., including discrete and integrated electronic circuitry), software portions (e.g., computer programming), and any combination thereof;
f) hardware portions may be comprised of one or both of analog and digital portions;
g) any of the disclosed devices or portions thereof may be combined together or separated into further portions unless specifically stated otherwise; and
h) no specific sequence order of acts is intended to be required unless specifically indicated.

We claim:

1. An optical disc recorder comprising:
an input for receiving user data;
a turntable for holding and rotating the optical disc;
a laser for producing a radiation beam;
an optical head with a lens system for directing the beam toward the disc for scanning the optical disc with the beam as the disc rotates;
a head servo for controlling the lateral position of the optical head with respect to the beam directed toward the disc to follow a predefined spiral or circular winding of a recording layer of the rotating disc and for controlling the axial position of the optical head with respect to the beam directed toward the disc to focus the beam into a spot on the winding;
a photo detector for converting the beam into an electronic read signal after the beam is reflected from the spot on the recording layer of the optical disc;
a controller adapted for controlling the laser to write the user data on the winding, the controller occasionally interrupting the writing in order to calibrate parameters of the drive in order to improve the write quality, the controller controlling the head servo to move the head back to a position just before the writing was interrupted and to determine the current position of the spot on the winding depending on an address determined from the read signal, and for controlling the turntable to reduce the rotational disc speed from a higher speed to a lower speed when the address can not be determined from the read signal at the higher speed.

2. The optical disc recorder of claim 1 wherein after determining the address at the lower speed, the controller increases the disc speed to the higher speed for continued writing of the user data.

3. A method of producing optically recorded discs, comprising:
providing a recordable optical disc with embossed windings of a spiral track or circular tracks in a recording layer of phase change material and with embossed address/timing information between adjacent windings;
receiving user data for recording on the disc;
writing the data by controlling a laser beam scanning the winding to form marks of different phases of the phase change material at a higher disc speed while reading an address from the disc;
occasionally interrupting the writing in order to calibrate write parameters in order to improve the write quality;
linking by jumping to a position just before the writing was interrupted, and determining the current position depending on an address read from the disc, and tracking to the position that the writing was interrupted, and continuing to write the user information to the disc;
reducing the disc speed when an error occurs in reading the address information from the disc;
rereading the address information at the slower disc speed,
continuing to write the data to the disc when the address information can be read at the slower disc speed.

4. The method of claim 3 wherein after reading the address at the lower speed, the disc speed is increased to the higher speed for continued writing of the user data.
